(19) United States
(12) Patent Application Publication
(10) Pub. No.: US 2026/0057322 A1
(43) Pub. Date: Feb. 26, 2026

(54) NEGOTIATING COLLECTIVE POSITIONAL EXCHANGES FOR PARTICIPANTS OF A QUEUING SYSTEM

(71) Applicant: American Express Australia Limited, Sydney (AU)

(72) Inventors: Lucky BIMOLAKSONO, Sydney (AU); Dean Ernest Arthur NICOLSON, Sydney (AU)

(73) Assignee: American Express Australia Limited, Sydney (AU)

(21) Appl. No.: 18/813,562

(22) Filed: Aug. 23, 2024

(51) Int. Cl. G06Q 10/0631; G06Q 30/0207

(52) U.S. Cl. CPC G06Q 10/06316; G06Q 30/0239

(57) ABSTRACT

A first queuing device moving from a first position to a second position may receive an indication of a collective positional exchange amount. The collective positional exchange amount may include a respective positional exchange amount for each of a plurality of queuing devices at respective positions between the first and second positions willing to exchange their positions with the first queuing device. In response to confirmation of the collective positional exchange amount received from the first queuing device, a value of the respective positional exchange amount for each of the plurality of queuing devices may be transferred to a respective account for the queuing device when an exchange between the current position of the first queuing device and the respective position of the queuing device occurs.

### BACKGROUND

In a queuing system e.g., a traffic system, an electronic queue, a wait and/or service line, etc.), participants (e.g., users, devices, etc.) may be unwilling to yield their position in the queuing system to other participants to decrease the service time for the other participants to move through the queuing system since it may increase the service time for the participants. Some participants may be willing to yield their position in the queuing system to other participants in exchange for a payment, value, credit, or other form of compensation from the other participants. For a participant providing a payment, value, credit, or other form of compensation paying for participants to yield their position in the queuing system may have little or no effect on a service time for the participant. Further, once a participant provides a payment, value, credit, or other forms of compensation for multiple participants to yield, another participant may opportunistically take advantage of the multiple participants by advancing their position or decreasing their service time in the queuing system without providing payment, value, credit, or other forms of compensation to the multiple participants. Participants in queuing systems are unable to negotiate collective positional exchanges within a queuing system.

### BRIEF SUMMARY

Disclosed herein are system, apparatus, device, method and/or computer program product embodiments, and/or combinations and sub-combinations thereof, for negotiating collective positional exchanges for participants of a queuing system. A first queuing device moving from a first position (e.g., physical location, virtual position, service/wait line position, etc.) to a second position may receive an indication of a collective positional exchange amount. The collective positional exchange amount may include a respective positional exchange amount for each of a plurality of queuing devices at respective positions between the first and second positions willing to exchange their positions with the first queuing device. Based on confirmation of the collective positional exchange amount received from the first queuing device, a value of the respective positional exchange amount for each of the plurality of queuing devices may be transferred to a respective account (e.g., digital wallet, micro-transaction account, etc.) for the queuing device when an exchange between the current position of the first queuing device and the respective position of the queuing device occurs.

### BRIEF DESCRIPTION OF THE DRAWINGS

The accompanying drawings are incorporated herein and form a part of the specification.

FIG. 1A shows a block diagram of an example a physical queuing environment, according to some aspects of this disclosure.

FIG. 1B depicts a block diagram of an example electronic queuing environment, according to some aspects of this disclosure.

FIG. 2 shows a flowchart of an example method for negotiating collective positional exchanges for participants of a queuing system, according to some embodiments.

FIG. 3 shows a flowchart of an example method for negotiating collective positional exchanges for participants of a queuing system, according to some embodiments.

FIG. 4 shows an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for negotiating collective positional exchanges for participants of a queuing system. A plurality of queuing devices that are each at a respective position of a plurality of positions between a first position (e.g., physical location, virtual position, service/wait line position, etc.) and the second position in a queuing system/environment (e.g., a traffic system, an electronic queue, a wait and/or service line, etc.), a geographical area, and/or the like may be identified. For example, the plurality of queuing devices may be identified and/or determined based on an indication that a first queuing device (e.g., vehicle and/or vehicle computing system, mobile device, etc.) will move from the first position to the second position. Each queuing device of the plurality of queuing devices may be associated with a respective positional exchange amount. For example, for each queuing device of the plurality of queuing devices, the respective positional exchange amount may be based on an exchange between a current position of the first queuing device and the respective position of the queuing device.

An indication of a collective positional exchange amount may be sent to the first queuing device based on a collective positional exchange amount satisfying a positional exchange amount threshold for the first queuing device. The collective positional exchange amount may include (and/or may be) a collection of the respective positional exchange amount for each queuing device of the plurality of queuing devices. The first queuing device may confirm the collective positional exchange amount. Based on the confirmation of the collective positional exchange amount, a value of the respective positional exchange amount for each queuing device of the plurality of queuing devices may be transferred from an account associated with the first queuing device to a respective account for the queuing device when the exchange between the current position of the first queuing device and the respective position of the queuing device occurs.

The system, apparatus, device, method and/or computer program product embodiments, and/or combinations and sub-combinations thereof, for negotiating collective positional exchanges for participants of a queuing system, as described herein provide improvements to at least the technological fields of queue system management and crowd control, and emergency response. For example, in an emergency situation and or scenario, a plurality of queuing devices, such as autonomous vehicles and/or the like, may be caused to automatically clear a path for an emergency response vehicle and/or device. The plurality of queuing devices cleared from the path of the emergency response vehicle and/or device may be provided a value token that may further incentivize immediate path clearing in emergency scenarios.

The system, apparatus, device, method and/or computer program product embodiments, and/or combinations and sub-combinations thereof, for negotiating collective positional exchanges for participants of a queuing system, as described herein enable participants in queuing systems are unable to effectively negotiate collective positional exchanges for participants of a queuing system. Further, if a participant provides a payment, value, credit, or other forms of compensation for multiple participants to yield, if additional participants opportunistically take advantage of the multiple participants by advancing their position or decreasing their service time in the queuing system without providing payment, value, credit, or other forms of compensation to the multiple participants, the multiple participants may be provided with a value token that may further incentivize negotiated collective positional exchanges for participants of a queuing system.

The system, apparatus, device, method and/or computer program product embodiments, and/or combinations and sub-combinations thereof, for negotiating collective positional exchanges for participants of a queuing system, as described herein facilitate efficient queue system management in areas including, but not limited to traffic in urban areas, where congestion and delays negatively impact productivity, fuel consumption, and the environment. Negotiated collective positional exchanges and behavior-based value tokens for participants of a queuing system serve to incentivize individual traffic decisions that positively influence overall traffic conditions. These and other advantages are described herein.

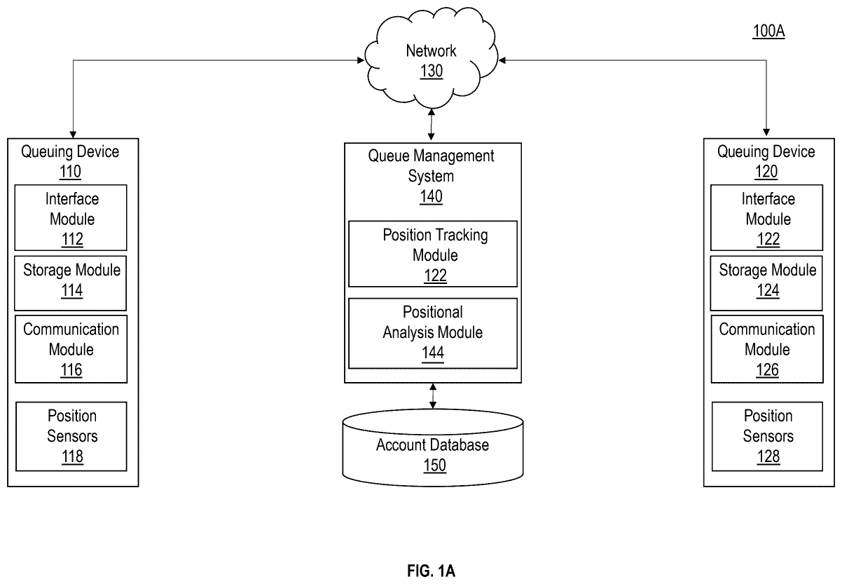

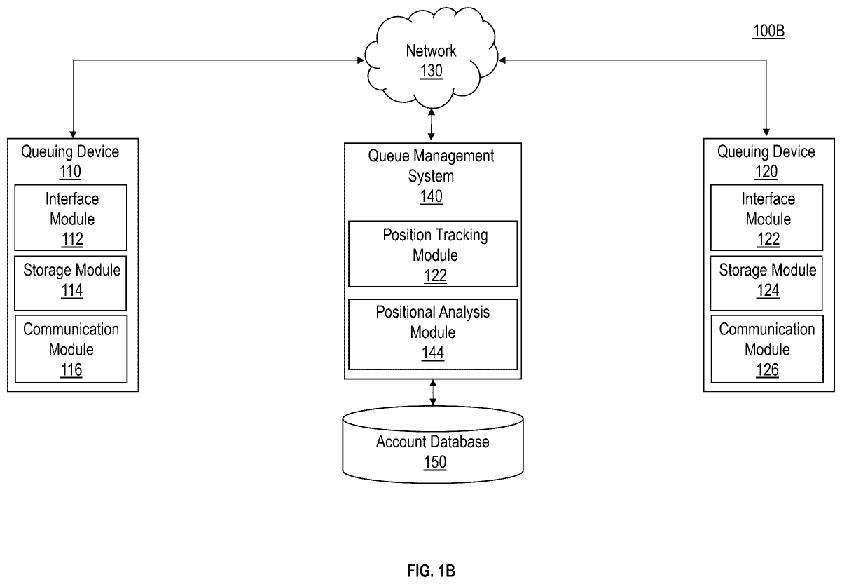

FIG. 1A shows an example queuing environment 100A. Queuing environment 100A may facilitate and/or support negotiating collective positional exchanges for participants of a queuing system. Queuing environment 100A is merely an example of one suitable environment and is not intended to suggest any limitation as to the scope of use or functionality of aspects described herein. Queuing environment 100A should not be interpreted as having any dependency or requirement related to any single device/module/component or combination of devices/modules/components described therein.

Queuing environment 100A may include a network 130. According to some aspects of this disclosure, network 130 may include a packet-switched network (e.g., internet protocol-based network), a non-packet-switched network (e.g., quadrature amplitude modulation-based network), and/or the like. According to some aspects of this disclosure, network 130 may include network adapters, switches, routers, modems, and the like connected through wireless links (e.g., radiofrequency, satellite) and/or physical links (e.g., fiber optic cable, coaxial cable, Ethernet cable, or a combination thereof). According to some aspects of this disclosure, network 130 may include public networks, private networks, wide area networks (e.g., Internet), local area networks, and/or the like. According to some aspects of this disclosure, network 130 may facilitate and/or support any short-range communication techniques (e.g., ultra-wideband (UWB), BLUETOOTH®, near-field communication, infrared, etc.) and/or long-range communication techniques (e.g., Internet, cellular, satellite, and the like). According to some aspects of this disclosure, network 130 may provide and/or support communication between queuing devices (e.g., autonomous vehicles, vehicle onboard computing devices, mobile devices, smart devices, Internet-of-Things (IoT) devices, etc.), a queue management system and/or other device/component of queuing environment 100A. For example, queuing environment 100A may facilitate and/or support communications between queuing device 110, queuing device 120, queue management system 140, and account database 150 via network 130.

Queuing devices 110 and 120 may include, but are not limited to, autonomous vehicles, vehicle onboard computing systems, smart devices, IoT devices, personal computing devices, mobile devices, portable/wearable devices, and/or the like. According to some aspects of this disclosure, queuing devices 110 and 120 may include, but are not limited to, interface modules 112 and 122, storage modules 114 and 124, communication modules 116 and 126, and position sensors 118 and 128, respectively.

Interface modules 112 and 122 enable users to interact with queuing devices 110 and 120, network 103, queue management system 140, and/or any other device/component of queuing environment 100A. Interface modules 112 and 122 may include any interface for presenting and/or receiving information (e.g., indications of service times, confirmation of service times, indications of request for positional exchange amounts, confirmation of positional exchange amounts, etc.) to/from users and/or queuing devices 110 and 120.

Interface modules 112 and 122 may include, but are not limited to, a web browser, a user interface of an application (e.g., a queue management application, etc.), and/or the like. Other software, hardware, and/or interfaces can be used to provide communication between users and/or queuing devices 110 and 120, network 103, queue management system 140, and/or any other device/component of queuing environment 100A.

Interface modules 112 and 122 may include one or more input devices and/or components, for example, such as a keyboard, a pointing device (e.g., a computer mouse, remote control), a microphone, a joystick, a tactile input device (e.g., touch screen, gloves, etc.), and/or the like. Input devices and/or components of interface modules 112 and 122 may include hardware input devices and/or components, software input devices and/or components, virtual input devices and/or components, physical input devices and/or components, and/or the like. According to some aspects of this disclosure, interaction with the input devices and/or components may enable a user to view, access, request, and/or navigate a user interface generated, accessible, and/or displayed by interface module 122. According to some aspects of this disclosure, interaction with the input devices and/or components may enable a user to manipulate and/or interact with components of a user interface, for example, to manage information related to service times, positional exchange amounts, and/or the like.

Storage modules 114 and 124 may store account information for queuing devices 110 and 120, respectively. For example, queuing devices 110 and 120 (e.g., users of queuing devices 110 and 120, etc.) may register a queuing system account (or access an existing queuing system account) on queuing devices 110 and 120. According to some aspects of this disclosure, queuing system accounts may be provided, supported, and/or managed by queue management system 140. For example, account database 150 may store queuing system accounts that are accessible to the queue management system 140.

According to some aspects of this disclosure, when queuing devices 110 and 120 (e.g., users of queuing devices 110 and 120, etc.) register or log in to a queuing system account, the queuing system account may be loaded at the corresponding queuing device. According to some aspects of this disclosure, account information corresponding to queuing devices 110 and 120 (e.g., users of queuing devices 110 and 120, etc.) may be temporarily stored by storage modules 114 and 124, respectively. Account information temporarily stored by storage modules 114 and 124 may include user preferences, payment information associated with a digital wallet, queuing device identifiers, and/or any other information related to queuing devices 110 and 120 (e.g., users of queuing devices 110 and 120, etc.).

Preferences (e.g., device preferences, user preferences, etc.) for queuing devices 110 and 120 (e.g., users of queuing devices 110 and 120, etc.) may be set and/or stored for the respective accounts before entering a queue and/or queuing system. For example, user preferences may indicate to the queue management system 140 conditions that must be met for queuing devices 110 and 120 (and/or users of the queuing devices) to exchange positions in the queue with each other and/or other queuing devices (and/or users of the queuing devices). The conditions may include, but are not limited to, factors such as time (e.g., how is a service time for the queue affected) and cost (what is the price for an exchange in position within a queue, etc.).

Each queuing system account may indicate device/user identifying information including, but not limited to, a name, an email address, address, account number, and/or the like. According to some aspects of this disclosure, storage modules 114 and 124 may store identifying information (e.g., license plate number, driver's license number, registration number, device serial number, entity identifiers, etc.) for queuing devices 110 and 120 (and/or users of the queuing devices) that exchanged between queuing devices 110 and 120 (and/or users of the queuing devices) to confirm an exchange in position in the queue. Queuing device identification information may also include physical location and/or relative position information. Users may provide consent to the information that is recorded and/or stored.

In some embodiments, queuing devices 110, 120 may be a dedicated device. For example, this may be a wearable device that may be persistent and/or bound to a user. This may include a theme park wristband, a concert venue lanyard, and/or other wearable devices. In some embodiments, the queuing device 110, 120 may not use a login and/or verification process. Rather, queue management system 140 may use an identifier and/or credentials corresponding to the queuing device 110, 120 for identification.

Queuing devices 110 and 120 may also include storage modules 114 and 124. Storage modules 114 and 124 may include and/or store a digital wallet (and/or digital wallet service) associated with a queuing system account. A digital wallet (and/or digital wallet service) may be used to settle a transaction between a first queuing device (e.g., queuing device 110, etc.) and a second queuing device (e.g., queuing device 120, etc.) after a negotiated exchange in position in a queue has occurred between queuing devices 110 and 120. According to some aspects of this disclosure, storage modules 114 and 124 may include payment information, passwords, transaction encryption keys, and/or communication encryption keys associated with the digital wallet associated with the corresponding queuing system account (e.g., associated with a user of the queuing system account). For example, the digital wallet may include payment card information. The payment card may be associated with a primary account number (PAN) that may be tokenized for security. PANs associated with queuing system accounts may be stored by account database 150. According to some aspects of this disclosure, monetary assets may be transferred between payment accounts associated with the digital wallet service information stored in storage modules 114 and 124. For example, digital wallet service information may identify a digital wallet. The digital wallet may correspond to a blockchain wallet, asset account, financial account, Central Bank Digital Currency (CBDC) wallet, government and/or state issued digital wallet, private wallet, business wallet, and/or another digital account capable of settling transactions, such as microtransactions. These transactions may occur and/or be settled in real-time.

According to some aspects of this disclosure, the value exchanged between the digital wallets may be in the form of a digital currency. A digital currency is a form of money that exists only in electronic form and is not backed by any physical commodity or legal tender. Digital currencies may be advantageous because they typically involve very low, near zero, transaction fees. These very low transaction fees may enable microtransactions to take place. Digital currencies can be created, stored, transferred, and exchanged using cryptography, peer-to-peer networks, and software protocols. Some examples of digital currencies are cryptocurrencies, such as Bitcoin and Ethereum, which operate on decentralized and distributed ledgers, and stablecoins, which are pegged to other assets or currencies to reduce volatility. The transactions may be microtransactions, which may include transactions in which the transaction amount is lower than the processing cost. The transactions may also include transaction amounts that are equal to or higher than the processing cost.

A central bank digital currency (CBDC) is a type of digital currency that is issued and regulated by a central bank as a legal tender and a liability of the central bank. A CBDC can be designed to have similar features and functions as cash, such as accessibility, anonymity, and finality, or to have additional capabilities, such as programmability, traceability, and interoperability. A CBDC can be implemented using different technologies and architectures, such as token-based or account-based, centralized or decentralized, wholesale or retail, and online or offline. Some examples of CBDC projects are the digital yuan in China, the e-krona in Sweden, and the sand dollar in the Bahamas.

Communication modules 116 and 126 may facilitate communication between queuing device 110 and queuing device 120. This may occur as direct wireless communications between the queuing devices 110 and 120 and/or may occur via network 130. Additionally, communication modules 116 and 126 may facilitate communication between queuing devices 110 and 120 and queue management system 140, via network 130. In some embodiments, communication modules 116 and 126 may also be used in a mesh network to route communications between a queueing devices 110 and 120 and queue management system 140. For example, first queuing device 110 may communicate with queue management system 140 via other queueing devices. These other queuing devices may pass connection and data from first queuing device 110 to queue management system 140. These other queueing devices may or may not include second queueing device 120. For example, in a system where second queueing device 120 is a counterparty to a transaction, there may be less trust between the two queuing devices 110, 120. First queuing device 110 may be wary that second queueing device 120 could modify and/or alter communications for their benefit. In this case, if first queuing device 110 communicates with queue management system 140 via a mesh network configuration, first queuing device 110 may transmit communications to other queuing devices (not pictured). Queuing devices 110, 112 may communicate with other queuing devices and/or queue management system 140 via communication modules 116 and 126.

Communication modules 116 and 126 may use a communication protocol (e.g., Ultra-wideband (UWB), Wi-Fi Direct, peer-to-peer Wi-Fi, Nearby Share, Multipeer Connectivity, infrared, etc.) to facilitate a peer-to-peer, ad hoc, and high-speed network and enable communication between queuing devices 110 and 120. Ultra-wideband is a radio technology that can use a very low energy level for short-range, high-bandwidth communications over a large portion of the radio spectrum. According to some aspects of this disclosure, the communication protocol used by communication modules 116 and 126 may enable a low latency/high-speed peer-to peer-connection. Utilizing a peer-to-peer connection reduces network resources required to accommodate various queuing environments that might have a large volume of queuing devices in a single queue, such as vehicles on a highway.

According to some aspects of this disclosure, in queuing environment 100A, queuing device 110 may be detected and/or identified via communication module 126 of queuing device 120, and vice versa. For example, queuing device 110 may transmit a queuing device identifier to second queuing device 120, and vice versa. According to some aspects of this disclosure, the identifier associated with queuing devices 110 and 120 may indicate a device type, an entity associated with the queuing device, and/or the like. According to some aspects of this disclosure, the identifier associated with queuing devices 110 and 120 may be tokenized and/or may depend on the type of queuing environment 100 is operating in. For example, in a highway-based queuing system or scenario, the tokenized identifier may be a license plate number, transponder, driver's license number, registration number, and/or other vehicle identifier. In a wait and/or service line scenario, the tokenized identifier may be a device identifier (e.g., a media access control (MAC) address, an International Mobile Equipment Identity (IMEI), etc.), a session identifier (e.g., an IP address, etc.), a user identifier and/or the like. In an emergency scenario and/or the like, an identifier may indicate that a queuing device is an emergency response device and/or associated with an emergency response system. A tokenized identifier may be any identifier used to identify queuing devices 110 and 120 (and/or users of the queuing devices).

For example, if the user preference indicates the user will manually determine queuing device 110 has exchanged positions in the queue with queuing device 120, then the queuing device identifier may be a visual identifier such as a license plate number. A user of queuing device 110 may confirm (e.g., via interface module 112, etc.) that queuing device 110 has exchanged positions with queuing device 120 by recognition of the queuing identifier. For example, an input and/or interaction with interface module 112 (e.g., an interactive element of interface module 112, etc.) may confirm the exchange.

In a scenario where queuing device 110 is an emergency response device and/or is associated with an emergency response device, an emergency response system/entity, and/or the like, queuing device 110 may transmit an identifier to other queuing devices (e.g., queuing device 120, etc.) and/or queue management system 140 that indicates queuing device 110 as such. An identification of queuing device 110 as an emergency response device and/or as being associated with an emergency response device, an emergency response system/entity, and/or the like may cause multiple queuing devices to automatically clear a path for queuing device 110 by exchanging positions and/or the like as queuing device 110 moves through a queuing system.

According to some aspects of this disclosure, queuing devices 110 and 120 may use position sensors 118 and 128, respectively, to autonomously verify a change in relative position in a queue and/or the like. For example, data (e.g., image data, ultrasonic data, beacon detection data, LIDAR data, etc.) from position sensors 118 and 128 may indicate an exchange in position in a queue has occurred. For example, in a highway-based queuing system and/or scenario, position sensor 118 may access and/or communicate with additional sensors of a sensor system (e.g. the blind spot detection system using ultrasonic or radar sensors, self-driving cars using LIDAR, front, rear, side or 360-degree cameras, or a combination of these sensors or systems used in vehicles) of queuing device 110 (e.g. a vehicle) to determine when another queuing device such as queuing device 120 (e.g. another vehicle) has changed position in queuing environment 100 relative to queuing device 110.

For example, position sensor 118 can verify the movement of queuing device 120 relative to queuing device 110 in queuing environment 100. Similarly, position sensor 128 can verify the movement of queuing device 110 relative to queuing device 120 in queuing environment 100. For example, in a highway-based queuing scenario (e.g., in traffic towards a destination, etc.), position sensor 118 may use the existing sensor infrastructure of the vehicle to verify the relative movement of queuing device 120 relative to queuing device 110. In queuing environment 100A, the relative movement may be a measurable distance because the queue is a physical queue. For example, the queue may be formed with vehicles on a highway or users with queuing devices in a physical line and/or in traffic towards destinations.

According to some aspects of this disclosure, communication modules 116 and 126 may enable position sensors 118 and 128 to communicate detected information between queuing devices 110 and 120, respectively. Queuing devices 110 and 120 may each be associated with a queuing device identifier and queuing system account stored in queuing system account database 150. When a transaction amount is negotiated and accepted for an exchange of position between queuing devices 110 and 120, queue management system 140 may send the queuing device identifier corresponding to queuing device 110 to queuing device 120 and the queuing device identifier corresponding to queuing device 120 queuing device 110. When the exchange in position occurs, communication interface 116 may send the queuing device identifier of queuing device 110 to queuing device 120. Queuing device 120 may in turn confirm that the queuing device identifier received from queuing device 110 matches the queuing device identifier received from queue management system 140. The same process can also be executed by queuing device 110.

For example, the exchange in position in the queue of queuing devices 110 and 120 may be automatically confirmed by queuing devices 110 and 120 using communication modules 116 and 126 and position sensors 118 and 128. Communication modules 116 and 126 may transmit the queuing device identifier and position sensors 118 and 128 may verify the change in position in the queue by using the existing sensors and infrastructure of queuing devices 110 and 120 to determine when another queuing device is moving to a position relative to queuing device 110 or queuing device 120.

According to some aspects of this disclosure, queuing devices (e.g., queuing devices 110 and 120, etc.) may use a different technique than previously described to determine whether a change in relative movement has occurred and whether there was an exchange in position in the queue. For example, queuing devices (e.g., queuing devices 110 and 120, etc.) may use a communication interface (e.g., communication modules 116 and 126, etc.) and position sensors (e.g., position sensors 118 and 128, etc.) to automatically confirm a change in relative position between queuing devices. Additionally, queue management system 140 may request, via network 130, other queuing devices in queuing environment 100 that are not involved in a positional exchange transaction to verify (e.g., via sensor data, etc.) the relative movement of queuing devices involved in positional exchange transactions to determine that an exchange in position in the queue occurred.

Communication modules 116 and 126 may additionally enable peer-to-peer wireless transfer of the value of the transaction between queuing devices 110 and 120 using digital wallet information stored in device memory 114 and 124 and/or the like. A transaction may be settled in real-time for a negotiated and/or accepted transaction amount. For example, digital wallets for queuing devices 110 and 120 may be used in microtransactions to exchange value for positional exchange transactions. Microtransactions may allow the queuing devices 110 and 120 to exchange positions in the queue multiple times according to the user preferences indicated at interface modules 112 and 122, respectively.

Communication modules 116 and 126 may also implement security protocols to provide secure identifiers, transaction information, and/or communications. Encryption, authentication, identity verification, and/or other security protocols would be used to ensure that queuing device identifiers being transmitted or used are accurate and/or legitimate. For example, the security protocols would provide protections against device identifiers being counterfeited, spoofed, replayed, and/or used without permission by bad actors.

Queue management system 140 may manage queuing system accounts for queuing devices (e.g., queuing devices 110 and 120, etc.). As previously described, users of queuing devices (e.g., queuing devices 110 and 120, etc.) may register a queuing system account with queue management system. Queuing system accounts may indicate user preferences, queuing device identifiers, user identifiers, user payment information, credential information, calendar information, GPS tracking information, usage and/or timestamped data, and/or the like.

Queuing system accounts may be linked to one or more bank/payment accounts and/or a digital wallet service. Digital wallet information may be transmitted to queuing devices 110 and 120, for example, when a user accesses and/or logs into an application configured with queuing devices 110 and 120 and associated with queue management system 140. According to some aspects of this disclosure, a digital wallet service may link queuing system accounts to virtual card tokens in queue management system 140.

According to some aspects of this disclosure, queuing devices 110 and 120 may generate logs that indicate other queuing devices that exchanged positions with queuing devices 110 and 120, respectively, as traversing a queuing system. The log may record one or more digital wallet identifiers and/or respective positional exchange amounts corresponding to other queuing devices that exchanged positions with queuing devices 110 and 120, respectively. Positional exchange amounts may be transferred, for example, based on the log and/or instruction from queue management system 140 to respective digital wallets for queuing devices that exchange positions with queuing devices 110 and 120, respectively. For example, queuing devices 110 and 120 may communicate with a digital wallet service to execute the transactions for positional exchange amounts according to the log maintained by queuing devices 110 and 120. For example, queuing devices 110 and 120 may send one or more digital wallet identifiers and/or respective positional exchange amounts from the log to the digital wallet service to transfer positional exchange amounts.

According to some aspects of this disclosure, queuing devices (e.g., queuing devices 110 and 120, etc.) may be associated with multiple queuing system accounts. For example, a user can log in to one or more devices capable of joining the queue and acting as a queuing device with the user's corresponding queuing system account. In some embodiments, the queuing device and/or the queuing management system may use GPS information, position sensor data, and/or detection data from other queuing devices to determine a queue for a particular queuing device. The user may automatically join the detected and/or suggested queue.

According to some aspects, queue management system 140 may implement countermeasures to prevent Sybil attacks and/or other attacks where a malicious actor attempts to create a large number of identities or accounts. For example, queue management system 140 may request a valid funding source and/or a nominal registration fee when registering a queue system account. The fee may be a microtransaction. This may discourage a threat actor from attempting to register hundreds or thousands of accounts. For example, the threat actor may face rapidly mounting costs that may discourage them from creating fake accounts. This may make the process economically unfeasible in terms of cost and time. In some embodiments, queue management system 140 may also use functional identity attestations and/or confirmations to prevent threat actors.

Queue management system 140 may include, facilitate, and/or support a value and/or reward system for queuing system devices. For example, in a traffic scenario, queue management system 140 may manage value tokens that may be used as a form of incentive to reward queuing devices (e.g., queuing devices 110 and 120, etc.) for behavior within a traffic system including, but not limited to, making good traffic decisions and/or the like.

For example, queue management system 140 may manage a token system that includes blockchain, distributed ledger, and/or the like for transparent and secure transactions of value tokens. Queue management system 140 may include, a positional analysis module 144. Positional analysis module 144 may receive, collect, and/or store information related to traffic patterns including, but not limited to, congestion levels, average speeds, route choices, and/or the like. For example, positional analysis module 144 may receive and store information such as GPS data from queuing devices, traffic camera and related sensor data, telemetry data positional data from applications configured with queuing devices, and/or the like.

Positional analysis module 144 may include one or more algorithms and/or trained predictive models that evaluate the impact of individual queuing device behavior (e.g., traffic decisions, etc.) on a queuing system (e.g., traffic system, etc.). For example, positional analysis module 144 may use historical queuing device data to determine if behavior such as taking an alternate route reduced congestion or improved service times. Positional analysis module 144 may use real-time queuing device data to identify behavior including, but not limited to: a queuing device taking, confiscating, and/or otherwise occupying a position where another queuing device was and/or intended to return to without providing the other queuing device a positional exchange amount; a queuing device moving from a position that blocks or inhibits a route/path for another queuing of a certain type (e.g., an emergency response vehicle, etc.) to allow the other queuing device to move along the route/path; and/or the like.

Positional analysis module 144 may assign values to identified behaviors within a queuing system. Value may be determined based on the severity of the problems solved by actions (e.g., enabling emergency response vehicles to pass, avoiding collisions, etc.), the impact on queuing system congestion and/or service times, or any other relevant factors. Values for identified behaviors may be represented as value tokens distributed to (or removed from) queuing system accounts. Value tokens may be accumulated and used in various ways including, but not limited to discounts on assets, exchanges for assets, donations to entities and/or causes, and/or the like.

Queue management system 140 may include, a position tracking module 142. Position tracking module 142 may track, for example, via an application configured with queuing devices (e.g., queuing devices 110 and 120, etc.), the position of each queuing device in queuing environment 100.

Positional analysis module 144 may use the position data from position tracking module 142 and user preferences to suggest a potential exchange of position between queuing device 110 and queuing device 120. Positional analysis module 144 may additionally recommend transaction amount for the exchange of position in queuing environment 100. The recommended transaction amount may be based on the user preferences associated with the queuing system accounts logged in at queuing devices 110 and 120. For example, positional analysis module 144 may suggest queuing device 110 exchange position in the queue with queuing device 120 for a specified positional exchange amount (e.g., currency amount, asset value, token value, etc.). The suggested positional exchange amount may depend on user preferences such as speed, time, economy, profit, cost, and/or other user-defined preferences. User input preferences of first queuing device 110 and second queuing device 120 may contribute to the recommended transaction amount presented at interface modules 112 and 122 from positional analysis module 144.

For example, user preferences associated with queuing device 110 may indicate that a user has a short timeline and is willing to pay a certain transaction amount to increase their position in a queue. User preferences of queuing device 120 may indicate that a user is not on a short timeline. For example, the user of queuing device 120 does not need or does not have a desire to increase the position of queuing device 120 in the queue. Queuing device 120 may also include a desired positional exchange amount for exchanging positions. In this case, if the desired positional exchange amount for exchanging position in the queue is within the budget of queuing device 110, then positional analysis module 144 may recommend the positional exchange amount for the transaction to queuing devices 110 and 120 corresponding to queuing device 120 yielding its position in the queue to first queuing device 110. In some embodiments, automated market maker (AMM) and/or a coincidence of wants (CoW) calculations, algorithms, and/or processes may be used as well.

According to some aspects of this disclosure, queue management system 140 may use user preferences for queuing devices to identify groups of queuing devices with respective positional exchange amounts that may be combined into a collective positional exchange amount that satisfies a positional exchange amount threshold (e.g., a willingness to pay, etc.) for queuing device 110 and may be exchanged with the queuing devices of the group of queuing devices for exchanges in positions.

According to some aspects of this disclosure, positional analysis module 144 may identify and/or forecast service times and/or changes in service times for a queuing system. A service time may include, but is not limited to, an amount of time associated with moving from a first position to a second position in a queuing system (e.g., a traffic system, an electronic queue, a wait and/or service line, etc.), a geographical area, and/or the like.

According to some aspects of this disclosure, positional analysis module 144 may determine a service time between a first location and a second location based on the distance between the first location and the second location using the most accurate route available, considering factors identified from a real-time sensor and/or third-party data including, but not limited to, road conditions, traffic congestion, reported accidents or events, and/or the like. For example, when determining a service time, positional analysis module 144 may incorporate real-time traffic information from GPS data and navigational/telemetry data from queuing devices within a queuing system. According to some aspects of this disclosure, positional analysis module 144 may aggregate real-time traffic information from GPS data and navigational/telemetry data from queuing devices within a queuing system to identify and detect traffic congestion, accidents, road closures, and other incidents that may affect service times. Positional analysis module 144 may adjust the forecasted and/or calculated service times based on any current conditions.

Positional analysis module 144 may access historical data about traffic patterns on different roads at different times to estimate the average speed of queuing devices on specific routes during different times of the day and days of the week. For example, positional analysis module 144 may forecast service times (e.g., travel times, etc.) based on historical usage and/or traffic patterns.

Positional analysis module 144 may continuously collect and analyze real-time data from queuing devices regarding attributes including, but not limited to, speed, velocity, location, and/or the like to update, identify, and/or change service times accordingly. Additionally, positional analysis module 144 may be trained to forecast how effective a change in position between queuing devices based on a positional exchange amount will have on a service time for the queuing system. For example, a change in a service time for queuing device 110 the move between a first location (e.g., an origin location/position, etc.) to a second location (e.g, a destination location/position, etc.) in the queuing system may be forecasted based on a positional exchange amount for queuing device 120 (and/or other queuing devices, etc.) and the position of queuing device 120 (and/or other queuing devices, etc.).

Positional analysis module 144 may include one or more trained predictive models. The predictive models may be trained to forecast queuing device groupings, service times, changes in service times, and/or the like based on positions and attributes (e.g., device types, entity associations, velocity, user preferences, environmental factors, etc.) for queuing devices.

Predictive models of positional analysis module 144 may include, but are not limited to, predictive models configured via a learning or training phase within a classifier constructor and task-specific feature selection module. According to some aspects of this disclosure, predictive models of positional analysis module 144 may be explicitly trained based on labeled datasets (generated from feature engineering, etc.) relating to, including, but not limited to attribute relationships between queuing devices, mapping and location information, positional exchange amounts, service times, transaction times, historical data describing the positions of devices in queues when exchanges of positions occur, queue system usage patterns, the absolute and relative positions in a queue, and/or the like. Training datasets may include features that describe the average change in service times given a certain positional exchange amount, time of day, day of the week, and/or the like. According to some aspects of this disclosure, predictive models of positional analysis module 144 may be trained on data derived from various queuing devices and other related devices within queuing environment 100A.

Positional analysis module 144 may select a predictive model that is appropriate for data and/or a given scenario, such as forecasting changes in service times for a queuing system. The predictive model(s) may include, but is not limited to, a regression model for forecasting a continuous outcome (e.g., a service time, etc.), or a classification model for forecasting a categorical outcome (e.g., whether a queuing device action is indicative of a type/category of behavior, whether an exchange will save more than a certain amount of time, etc.). According to some aspects of this disclosure, predictive models of positional analysis module 144 may include linear regression, decision trees, random forests, gradient boosting machines, neural networks, and/or the like suitable for negotiating collective positional exchanges for participants of a queuing system, forecasting service times and related information, and/or the like.

When training the predictive model(s) of positional analysis module 144, data used in developing datasets may be split into a training set and a validation set, where the training set is used to train the predictive model(s) and the validation set is used to tune the predictive model(s) parameters and avoid overfitting. Performance of the the predictive model(s) may be evaluated according to relevant metrics. For example, for regression tasks, a relevant metric may be mean absolute error (MAE) or root mean square error (RMSE). For classification tasks, a relevant metric may include, but is not limited to, accuracy, precision, recall, and/or the like.

Once the predictive model(s) of positional analysis module 144 is trained and evaluated, it can be used to make predictions on new data. The predictive model(s) may be periodically retrained on new data, to ensure the predictive model(s) remains accurate as conditions change. According to some aspects of this disclosure, when identifying queuing device groupings, forecasting service times, forecasting changes in service times and/or the like for a queuing system, predictive models of positional analysis module 144 may utilize third-party information (e.g., navigational information from a navigation service, crowd-sourced routing information, live data associated with the queuing system, and/or the like to optimize predictions and/or recommendations.

Positional analysis module 144 may use a predictive model, real-time data (e.g., data from queuing devices, sensor data, etc.), queuing system accounts (e.g., group/membership information indication association between queuing devices, positional exchange value thresholds, entity associations, etc.), and/or the like to identify certain queuing devices (e.g., positional exchange buyers, positional exchange sellers, etc.) within a queuing system and negotiate positional exchanges. For example, in a scenario where queuing device 110 is moving from a first position (e.g., physical location, virtual position, service/wait line position, etc.) to a second position, positional analysis module 144 may cause an indication of a collective positional exchange amount to be sent to queuing device 110. The collective positional exchange amount may include a respective positional exchange amount for each of a plurality of queuing devices at respective positions between the first and second positions willing to exchange their positions with the first queuing device.

Queuing device 110 may confirm the collective positional exchange amount. Based on the confirmation, positional analysis module 144 may cause a value of the respective positional exchange amount for each of the plurality of queuing devices to be transferred to a respective account (e.g., digital wallet, micro-transaction account, etc.) for the queuing device when an exchange between the current position of the first queuing device and the respective position of the queuing device occurs.

In some embodiments, positional recommendation and service time analysis module 144 may also consider user history and/or information corresponding to previous usage of a queuing device 110, 120 and/or queue management system 140. Queue management system 140 may also track usage metrics, engagement scores, loyalty program data, and/or user status tiers. For example, a high usage user may be granted a VIP tier or designation. In some embodiments, queue management system 140 may adjust price calculations and/or queue prioritization for users based on the user's history and/or usage metrics.

FIG. 1B, shows an example block diagram of an electronic queuing environment 100B, according to some embodiments. Electronic queuing environment 100B may be a modified version of queuing environment 100A of FIG. 1A, therefore many of the devices and/or components of queuing environment 100B operate and/or perform similar or the same as described for queuing environment 100A.

According to some aspects of this disclosure, queuing environment 100B may correspond to a scenario where queuing devices 110 and 120 are participants in an electronic queue. For example, the electronic queue may correspond to ticket sales on a website. Users with corresponding queuing system accounts may be placed in a queue prior to being allowed to purchase tickets to a concert, show, sporting event, and/or other ticketed event. Queue management system 140 may manage the electronic queue to avoid overwhelming ticket system resources in ticket distribution. Users may use queuing devices 110 and 120 to join the electronic queue and/or view their corresponding position in the queue. As further explained below, users may use queuing devices 110 and 120 to exchange positions in the queue. Queue management system 140 may facilitate transactions between queuing system accounts to facilitate the exchange of a positional exchange amount for queue position between users of queuing devices 110 and 120.

In some embodiments, the queue system account may also store and/or use queuing device identifying information in the context of ticket sales. For example, in the context of online ticket sales, this information may be used to determine an initial position of the user account and/or a price or priority for exchanging positions. In some embodiments, data may also be gathered from other systems and/or connections. For example, users may consent to having data gathered from a streaming service, such as a video or music streaming service, and/or from a social media platform. For example, if the user is a fan of a particular band or musical act, the data may be gathered to indicate fan may engagement. Such information may be used to provide preferential queue positions and/or may be used to provide different or cheaper exchange rates. For example, exchange rates for users trading positions may be modified based on the users' engagement with the particular band or musical act. This engagement may be measured based on the data gathered from the social media platforms and/or streaming services. Queue management system 140 may also use other application data and/or observed historical outcomes to aid in providing a suggested exchange condition and/or a time/cost suggestion.

As described for queuing environment 100A, for queuing environment 100B, queue management system 140 may include position tracking module 142 and positional analysis module 144. Position tracking module 142 may track the position of each account corresponding to the queuing devices in queuing environment 100B. Position tracking module 142 may manage the electronic queue, manage queue position information, and/or provide queue position information to queuing devices (e.g., queuing devices 110 and 120, etc.). According to some aspects of this disclosure, queue management system 140 may facilitate exchanges of positions while a separate system facilitates the electronic queue. In this scenario, queue management system 140 may receive position information from the separate system managing the electronic queue. For example, when the electronic queue is for ticket sales on a website, queuing system 140 may communicate via network 130 with the electronic queue and the electronic queue may provide user position tracking module 142 of queue management system 140 position data for each of the queuing devices in the electronic queue.

According to some aspects of this disclosure, within electronic queuing environment 100B, queuing devices (e.g., queuing devices 110 and 120, etc.) may include, but are not limited to smart devices, personal computing devices, mobile devices, portable/wearable devices, and/or the like that are capable of entering (e.g., via an application, online service, etc.) a digital queue.

Queue management system 140 may communicate changes in electronic queue positions to queuing devices 110 and 120. For example, queuing device 110 may exchange position in an electronic queue with queuing device 120. According to some aspects of this disclosure, this may occur when an account corresponding to queuing device 110 exchanges positions with an account corresponding to queuing device 120. Queuing device 110 and queuing device 120 may communicate the desire to exchange positions in the queue to queue management system 140. For example, queue management system 140 may transmit data to queuing device 110 to display a graphical user interface prompt. The prompt may provide an offer to the user to change positions in the electronic queue for a positional exchange amount, such as a particular transaction and/or microtransaction fee or exchange. For example, the exchange may be an exchange of positions between accounts corresponding respectively to queuing devices 110 and 120. A first account corresponding to queuing device 110 may take the place of a second account corresponding to queuing device 120 in the electronic queue. A positional exchange amount may be transferred from the first account to the second account in response to this exchange of position. The change in position in the queue may be entered manually, for example, the users queuing device 110 and queuing device 120 may confirm their desire to exchange positions in the queue via interface modules 112 and 122. Queue management system 140 may then exchange the positions of queuing devices 110 and 120 in the electronic queue and/or verifies that they correctly exchanged position if the electronic queue is managed by a separate system. According to some aspects of this disclosure, queue management system 140 may autonomously verify the exchange of the positions of queuing devices 110 and 120 in the electronic queue, for example through the source code of the electronic queue or communication with the electronic queue.

As described for queuing environment 100A, within queuing environment 100B, queue management system 140 may also manage queuing system accounts of various users. Similarly, positional analysis module 144 may identify queuing device groupings and forecast changes in service times for a queuing system, such as an electronic queue. For example, user preferences from queuing device 110 may indicate that the user has a short timeline and/or wishes to purchase tickets before they become unavailable. The preference may indicate a willingness to pay a certain transaction amount to increase their position in a queue. User preferences of queuing device 120 and other queuing devices may indicate that users of queuing device 120 and the other queuing devices are not on a short timeline and/or have less of a desire to obtain tickets. For example, users of queuing device 120 and the other queuing devices do not need or do not have a desire to increase their position in the queue. User preferences may also include a desired profit amount for exchanging positions. In this case, if the collective desired profit for exchanging positions with queuing device 120 and the other queuing devices in the queue is within the budget of queuing device 110, then positional analysis module 144 may recommend a collective transaction amount to queuing device 110, queuing device 120, and the other queuing devices corresponding to queuing device 120 and other queuing devices yielding their position in the queue to queuing device 110.

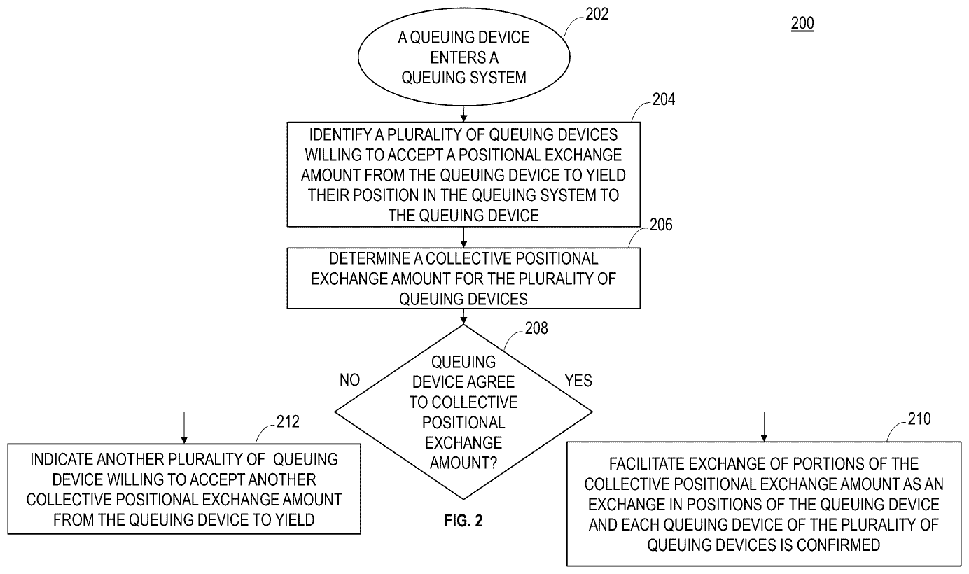

FIG. 2 shows a flowchart of an example method 200 for negotiating collective positional exchanges for participants of a queuing system, according to some aspects of this disclosure. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIGS. 1A-1B. However, method 200 is not limited to the aspects of those figures.

In 202, a queuing device (e.g., queuing device 110) enters (e.g., via a log into an application and/or service, etc.) a queuing system. The queuing system may be for a traffic system, for example, such as vehicles on the highway. According to some aspects of this disclosure, queue management system 140 may determine a service time for a move from a first position (e.g., an origin of the queuing device, etc.) to a second position (e.g., a destination of the queuing device, etc.).

In 204, queue management system 140 identifies a plurality of queuing devices willing to accept a positional exchange amount from the queuing device (e.g., queuing device 110) to yield their position in the queuing system to the queuing device (e.g., queuing device 110). For example, queue management system 140 may identify queuing devices that have accessed and/or logged into a queuing system application and/or the like and have indicated a willingness to accept positional exchange amounts as well as requested values for the positional exchange amounts. Additionally, pluralities of queuing devices may be grouped and/or identified based on various factors including, but not limited to, type of queuing devices (e.g., autonomous queuing devices vs. manually controlled queuing devices, etc.), queuing devices with respective positional exchange amounts that are within a certain range of positional exchange amounts, respective positions of queuing devices and potential affects exchanges of respective positions have on a service time, and/or the like.

In 206, queue management system 140 determines a collective positional exchange amount (e.g., a collective microtransaction payment amount, etc.) that includes a total of each respective positional exchange amount (e.g., a microtransaction payment amount, etc.) for each queuing device of the plurality of queuing devices. According to some aspects of this disclosure, if the collective positional exchange amount satisfies a collective positional exchange amount threshold for the queuing device (e.g., queuing device 110), an indication of the collective positional exchange amount may be sent to the queuing device (e.g., queuing device 110).

According to some aspects of this disclosure, queue management system 140 may forecast changes in the service time based on position exchanges between the queuing device (e.g., queuing device 110) and the plurality of queuing devices. According to some aspects of this disclosure, queue management system 140 may use live data associated with the queuing system (e.g. maps, current speeds of queuing devices versus posted speed limits, etc.) and the willingness indicated by the plurality of queuing devices to yield to the queuing device (e.g., queuing device 110) to determine if the queuing device (e.g., queuing device 110) may successfully provide a collective positional exchange amount to the plurality of queuing devices to yield. For example, according to some aspects of this disclosure, sending the indication of if the collective positional exchange amount to the queuing device (e.g., queuing device 110) may be based on the collective positional exchange amount threshold for the queuing device (e.g., queuing device 110), and whether the collective positional exchange will provide a certain amount of change in service time for the queuing device (e.g., queuing device 110).

In 208, queue management system 140 may receive confirmation of the collective positional exchange amount and method 200 progresses to step 210. According to some aspects of this disclosure, confirmation of the collective positional exchange amount may be received based on an interaction with a user interface element displayed by the queuing device (e.g., queuing device 110). According to some aspects of this disclosure, confirmation of the collective positional exchange amount may be received based on any other manual response action initiated by and/or associated with the queuing device (e.g., queuing device 110) and/or a user of the queuing device. According to some aspects of this disclosure, confirmation of the collective positional exchange amount may be automatically initiated by the queuing device (e.g., queuing device 110), for example, if the collective positional exchange amount satisfies a collective positional exchange amount threshold set by (e.g., via user preferences, etc.) the queuing device (e.g., queuing device 110). According to some aspects of this disclosure, confirmation of the collective positional exchange amount may be received based on any other automated response action initiated by and/or associated with the queuing device (e.g., queuing device 110).

If confirmation of the collective positional exchange amount is not received and/or if the collective positional exchange amount is rejected by the queuing device (e.g., queuing device 110), method 200 progresses to step 212.

In 210, queue management system 140 may facilitate an exchange of the respective positional exchange amount for each of the plurality of queuing devices from the collective positional exchange amount between the queuing device (e.g., queuing device 110) and each queuing device of the plurality of queuing devices once an exchange in positions between the queuing device and the queuing device of the plurality of queuing devices is confirmed.

In 212, when confirmation of the collective positional exchange amount is not received and/or if the collective positional exchange amount is rejected by the queuing device (e.g., queuing device 110) in step 208, queue management system 140 may identify and indicate to the queuing device (e.g., queuing device 110) another plurality of queuing devices (e.g., another plurality of queuing devices that have accessed and/or logged into a queuing system application, etc.) willing to accept another and/or different collective positional exchange amount from the queuing device to yield. The different collective positional exchange amount may be more cost-effective for the queuing device (e.g., queuing device 110) and/or may satisfy another parameter for the queuing device (e.g., queuing device 110) that was not satisfied by the original collective positional exchange amount.

Queue management system 140 may also identify another change in the service time. For example, the change in the service time may be different from the first change in the service time identified for the previous plurality of queuing devices. The new change in the service time may be a more optimal and/or advantageous change in the service time for the queuing device (e.g., queuing device 110) than the first change in the service time.

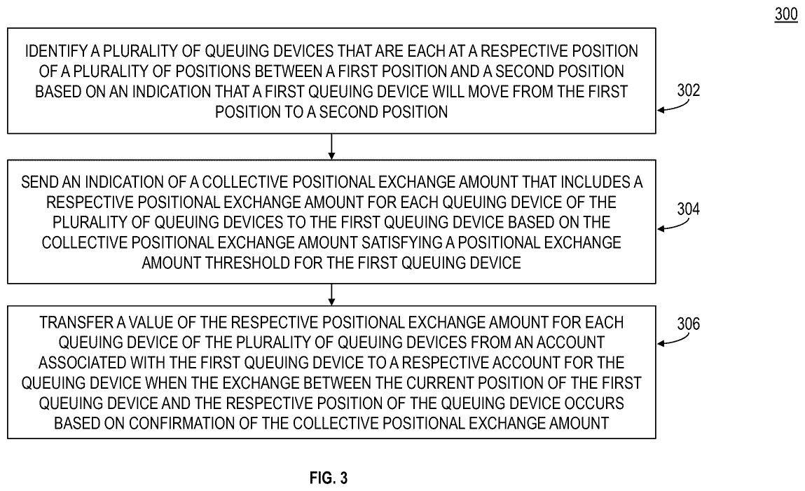

FIG. 3 shows a flowchart of an example method 300 for negotiating collective positional exchanges for participants of a queuing system, according to some aspects of this disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIGS. 1A-1B. However, method 300 is not limited to the aspects of those figures.

In 302, queue management system 140 identifies a plurality of queuing devices that are each at a respective position of a plurality of positions between a first position and a second position. Queue management system 140 may identify the plurality of queuing devices responsive an indication that a first queuing device will move from the first position to the second position.

For example, queue management system 140 may receive an indication that a first queuing device (e.g., queuing device 110, etc.) will move from the first position to the second position. The first queuing device may send a request for routing instructions, directions, and/or the like from the first position to the second position. According to some aspects of this disclosure, the first queuing device may send a notification to queue management system 140 that there is an intent to move the first queuing device from the first position to the second position. According to some aspects of this disclosure, the first queuing device may include a vehicle onboard computing device, a mobile device, and/or the like. In some embodiments, a graphical user interface on the first queuing device may include a dial or a slider. This may include a moveable marker on a spectrum. The spectrum may depict a correlation between a particular length in time and a cost. For example, a user may select to pay a higher cost to spend less time in the queue. Similarly, a user may select a lower cost and/or choose to receive funding to spend more time in the queue.

Each queuing device of the plurality of queuing devices may be associated with a respective positional exchange amount. For example, the respective positional exchange amount for each queuing device of the plurality of queuing devices may be an amount requested and/or required by the queuing device to exchange a current position of the first queuing device for the respective position of the queuing device. According to some aspects of this disclosure, each queuing device of the plurality of queuing devices may include a vehicle onboard computing device, a mobile device, and/or the like. For example, in a traffic scenario, the respective position for each queuing device of the plurality of queuing devices may be a moving, transient, and/or relative position in an area, such as a relative position along a path and/or route between the first position and the second position.

According to some aspects of this disclosure, queue management system 140 may determine a service time for a move from a first position to a second position. According to some aspects of this disclosure, a service time may include, but is not limited to, an amount of time associated with moving from a first position to a second position in a queuing system (e.g., a traffic system, an electronic queue, a wait and/or service line, etc.), a geographical area, and/or the like. According to some aspects of this disclosure, queue management system 140 may determine the service time for the move from the first position to the second position based on map information that indicates a distance or a travel rate between the first position and the second position.

Queue management system 140 may determine the service time for the move from the first position to the second position based on an indication of a velocity of the first queuing device and speed/velocity information for a route between the first position to a second position. According to some aspects of this disclosure, queue management system 140 may determine the service time for the move from the first position to the second position based on a previous service time for a move from the first position to the second position. According to some aspects of this disclosure, queue management system 140 may determine the service time for the move from the first position to the second position based on third-party information (e.g., navigational information from a navigation service, crowd-sourced routing information, etc.) that indicates the service time. According to some aspects of this disclosure, queue management system 140 may use any method or technique to determine the service time for the move from the first position to the second position.

According to some aspects of this disclosure, queue management system 140 determines the service time for the move from the first position to the second position based on the respective position of each queuing device of the plurality of queuing devices input to a predictive model trained to forecast service times and changes in services times based on positions and attributes of devices (e.g., queuing devices, sensors, IoT devices, and/or related devices along a route/path between positions, etc.). The predictive model may output the service time.

In 304, queue management system 140 sends an indication of a collective positional exchange amount to the first queuing device. The collective positional exchange amount may include the respective positional exchange amount for each queuing device of the plurality of queuing devices. Queue management system 140 may send the indication of the collective positional exchange amount to the first queuing device based on the collective positional exchange amount satisfying a positional exchange amount threshold for the first queuing device.

As described, queue management system 140 may determine a change in the service time for the first queuing device to move from the first position to the second position based on the respective position of each queuing device of the plurality of queuing devices input to a predictive model trained to forecast changes in service times based on positions and attributes (e.g., velocity, device type, user profiles, etc.) of devices and/or conditions (e.g., traffic conditions, weather conditions, topology, historical service times, operable and/or inoperable services, etc.) of the queuing system, geographical area, and/or the like.

According to some aspects of this disclosure, queue management system 140 may determine the change in the service time in response to an indication that an account value for the first queuing device satisfies an account value threshold. For example, queue management system 140 may determine that the first queuing device has an adequate amount of funds to transfer to a device(s) to take advantage of changes in the service time before evaluating and/or forecasting any change in the service time.

According to some aspects of this disclosure, queue management system 140 sending to the first queuing device the indication of the collective positional exchange amount may be further based on an amount of time associated with the change in the service time satisfying a changed time threshold for the first queuing device.

In 306, queue management system 140 transfers a value of the respective positional exchange amount for each queuing device of the plurality of queuing devices from an account associated with the first queuing device to a respective account for the queuing device. For example, queue management system 140 may cause the value of the respective positional exchange amount for each queuing device of the plurality of queuing devices to be transferred from the account associated with the first queuing device to the respective account for the queuing device based on confirmation of the collective positional exchange amount received from the first queuing device. Queue management system 140 may transfer the value of the respective positional exchange amount for each queuing device of the plurality of queuing devices from the account associated with the first queuing device to the respective account for the queuing device when the exchange between the current position of the first queuing device and the respective position of the queuing device occurs. For example, to transfer the positional exchange amount, queue management system 140 may transmit a command to a digital wallet service instructing the digital wallet service to perform the transfer.

According to some aspects of this disclosure, responsive to queue management system 140 receiving a confirmation (e.g., based on an interaction with an interactive element of a user interface of the first queuing device, etc.) of the collective positional exchange amount from the first queuing device, queue management system 140 may verify that the exchange between the current position of the first queuing device and the respective position of each queuing device of the plurality of queuing devices occurs. Based on verification, the respective positional exchange amount may be transferred from the account associated with the first queuing device to the respective account associated with each queuing device of the plurality of queuing devices as (or shortly after) the exchange between the current position of the first queuing device and the respective position of each queuing device of the plurality of queuing devices occurs.

For example, to transfer the value of the respective positional exchange amount for each queuing device of the plurality of queuing devices from the account associated with the first queuing device to a respective account for the queuing device, queue management system 140 may send an instruction to the first queuing device 110 to issue a command to a digital wallet service to transfer the respective positional exchange amount. As previously described the transfer of the respective positional exchange amount for each queuing device of the plurality of queuing devices from the account associated with the first queuing device to the respective account for the queuing device may be a microtransaction.

According to some aspects of this disclosure, the use of microtransactions may enable the first queuing device to continue to exchange positions and/or transact with additional queuing devices in the queue. For example, first queuing device may log and/or record transactions for positional exchange amounts while traversing a queuing system, and instead of contemporaneous transfers of positional exchange amounts as exchange of positions occurs, first queuing device may settle transactions for positional exchange amounts at a conclusion of traversing the queuing system (e.g., when the first queuing device arrives at the second locations, etc.). In some embodiments, first queuing device 110 may communicate with a digital wallet service and/or queue management system 140 to execute the transactions and/or transfers in the log. According to some aspects of this disclosure, first queuing device may transmit one or more identifiers for queuing devices of the plurality of queuing devices from the log to a digital wallet service to transfer the respective positional exchange amount. According to some aspects, queue management system 140 may communicate with the digital wallet service and/or may transmit the identifiers to the digital wallet service to transfer the respective positional exchange amount.

According to some aspects of this disclosure, the method 300 may further include queue management system 140 determining that a time window during which an exchange between a current position of a second queuing device and the respective position of a queuing device of the plurality of queuing devices occurs after the exchange between the current position of the first queuing device and the respective position of the queuing device occurs is less than a queuing device exchange time threshold. For example, the queuing device of the plurality of queuing devices may yield its respective position to the first queuing device, and before the queuing device may return to its respective position in a queuing system, a second queuing device may swoop in and take, confiscate, and/or otherwise occupy the respective position where the queuing device was and/or intended to return to without providing the queuing device a positional exchange amount.

As such, based on the determining that the time window is less than the queuing device exchange time threshold, queue management system 140 may cause a value token (e.g., a reward amount, a value credit, etc.) to be transferred to a respective account for the queuing device. According to some aspects of this disclosure, the value token may be transferrable for a product, an asset, a service, and/or the like. According to some aspects of this disclosure, queue management system 140 may remove a value token from an account for the second queuing device when the second queuing device registers with a queuing system based on the determining that the time window is less than the queuing device exchange time threshold. For example, queue management system 140 may employ a negative credit system (e.g., removal of value tokens, etc.) to incentivize good and/or proper behavior within the queuing system. Queue management system 140 may maintain a timestamped record of positional exchange occurrences and/or negotiated positional exchange amounts that may be used to identify specific events within the queuing system.

According to some aspects of this disclosure, the method 300 may further include queue management system 140 identifying another plurality of queuing devices that are each at a respective position of a plurality of positions between a third position and a fourth position. Queue management system 140 may identify the another plurality of queuing devices in response to receiving an identifier that indicates at least of a device type of a second queuing device or an entity associated with the second device, and an indication that the second queuing device is moving from the third position to the fourth position. For example, in a scenario when a second queuing device includes an onboard computing system of (and/or mobile device associated with) an emergency response vehicle (e.g., police, ambulance, firefighter, security, etc.), queue management system 140 may receive an identifier (and/or other indicator) of the second queuing device that informs queue management system 140 that the second queuing device is an emergency response device and/or associated with an emergency response entity/device. For each queuing device of the another plurality of queuing devices, queue management system 140 may transfer a value token to a respective account for the queuing device when an exchange between a current position of the second queuing device and the respective position of the queuing device occurs.

According to some aspects of this disclosure, in a scenario where queuing devices of the another plurality of queuing devices include onboard computing systems for autonomous vehicles and/or the like, queue management system 140 may send an instruction to the queuing device of the another plurality of queuing devices that causes the queuing device to move (e.g., automatically, etc.) from the respective position when the current position of the second queuing device is in proximity to the queuing device.

According to some aspects of this disclosure, the display and/or selection of a positional exchange amount may occur prior to a user operating a vehicle. For example, the user may select a positional exchange amount prior to embarking on a journey. In some embodiments, the display and/or selection may occur while the vehicle in motion. In this case, protections against distracting drivers may be implemented. For example, audio may be used and/or voice commands may be used to accept a suggested positional exchange amount. In some embodiments, a temporary screen lockout may occur to prevent a driver from shifting his or her focus to the user interface. The temporary screen lockout may occur when multiple interactions within a predetermined time window are detected. These measures to limit driver interactions while a vehicle is in motion may promote safety and/or minimize driver distractions.

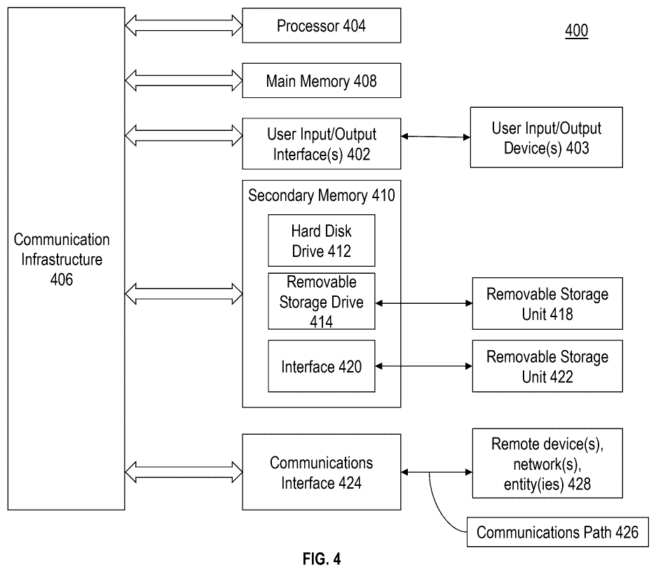

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406. In some embodiments, processor 404 may include an encryption system. This may be used to provide transaction security and/or to pass secure and/or trusted data. In some embodiments, the encryption system may be a physical secure element chip. The encryption system may also use a kernel and/or other certified software element to provide encryption and/or decryption of communications and/or messages. Such functionality may be implemented using one or more processors, such as processor 404.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for negotiating collective positional exchanges for participants of a queuing system, the method comprising:
identifying, based on an indication that a first queuing device will move from a first position to a second position, a plurality of queuing devices that are each at a respective position of a plurality of positions between the first position and the second position,
wherein each queuing device of the plurality of queuing devices is associated with a respective positional exchange amount,
wherein, for each queuing device of the plurality of queuing devices, the respective positional exchange amount is based on an exchange between a current position of the first queuing device and the respective position of the queuing device;
sending to the first queuing device, based on a collective positional exchange amount satisfying a positional exchange amount threshold for the first queuing device, an indication of the collective positional exchange amount,
wherein the collective positional exchange amount comprises the respective positional exchange amount for each queuing device of the plurality of queuing devices; and
transferring, based on confirmation of the collective positional exchange amount received from the first queuing device, a value of the respective positional exchange amount for each queuing device of the plurality of queuing devices from an account associated with the first queuing device to a respective account for the queuing device when the exchange between the current position of the first queuing device and the respective position of the queuing device occurs.

2. The computer-implemented method of claim 1, further comprising:
determining a service time for the move from the first position to the second position based on at least one of: map information that indicates a distance or a travel rate between the first position and the second position, an indication of a velocity of the first queuing device, a previous service time for the move from the first position to the second position, or third-party information that indicates the service time; and
determining, based on the respective position of each queuing device of the plurality of queuing devices input to a predictive model trained to forecast changes in service times based on positions and attributes of devices, a change in the service time,
wherein the sending to the first queuing device the indication of the collective positional exchange amount is further based on an amount of time associated with the change in the service time satisfying a changed time threshold for the first queuing device.

3. The computer-implemented method of claim 1, further comprising:
determining that a time window during which an exchange between a current position of a second queuing device and the respective position of a queuing device of the plurality of queuing devices occurs after the exchange between the current position of the first queuing device and the respective position of the queuing device occurs is less than a queuing device exchange time threshold; and
transferring, based on the determining that the time window is less than the queuing device exchange time threshold, a value token to the respective account for the queuing device.

4. The computer-implemented method of claim 3, further comprising:
removing a value token from an account for the second queuing device when the second queuing device registers with a queuing system based on the determining that the time window is less than the queuing device exchange time threshold.

5. The computer-implemented method of claim 1, further comprising:
identifying another plurality of queuing devices that are each at a respective position of a plurality of positions between a third position and a fourth position based on:
a received identifier that indicates at least of a device type of a second queuing device or an entity associated with the second device, and
an indication that the second queuing device is moving from the third position to the fourth position; and
transferring, for each queuing device of the another plurality of queuing devices, a value token to a respective account for the queuing device when an exchange between a current position of the second queuing device and the respective position of the queuing device occurs.

6. The computer-implemented method of claim 5, wherein, for each queuing device of the another plurality of queuing devices, the transferring the value token to the respective account further comprises sending an instruction to the queuing device that causes the queuing device to move from the respective position when the current position of the second queuing device is in proximity to the queuing device.

7. The computer-implemented method of claim 1, wherein at least one of the first queuing device or the plurality of queuing devices comprises at least one of a vehicle onboard computing device or a mobile device.

8. A system, comprising:
a memory; and
at least one processor coupled to the memory and configured to perform operations for negotiating collective positional exchanges for participants of a queuing system, the operations comprising:
identifying, based on an indication that a first queuing device will move from a first position to a second position, a plurality of queuing devices that are each at a respective position of a plurality of positions between the first position and the second position,
wherein each queuing device of the plurality of queuing devices is associated with a respective positional exchange amount,
wherein, for each queuing device of the plurality of queuing devices, the respective positional exchange amount is based on an exchange between a current position of the first queuing device and the respective position of the queuing device;
sending to the first queuing device, based on a collective positional exchange amount satisfying a positional exchange amount threshold for the first queuing device, an indication of the collective positional exchange amount,
wherein the collective positional exchange amount comprises the respective positional exchange amount for each queuing device of the plurality of queuing devices; and
transferring, based on confirmation of the collective positional exchange amount received from the first queuing device, a value of the respective positional exchange amount for each queuing device of the plurality of queuing devices from an account associated with the first queuing device to a respective account for the queuing device when the exchange between the current position of the first queuing device and the respective position of the queuing device occurs.

9. The system of claim 8, the operations further comprising:
determining a service time for the move from the first position to the second position based on at least one of: map information that indicates a distance or a travel rate between the first position and the second position, an indication of a velocity of the first queuing device, a previous service time for the move from the first position to the second position, or third-party information that indicates the service time; and
determining, based on the respective position of each queuing device of the plurality of queuing devices input to a predictive model trained to forecast changes in service times based on positions and attributes of devices, a change in the service time,
wherein the sending to the first queuing device the indication of the collective positional exchange amount is further based on an amount of time associated with the change in the service time satisfying a changed time threshold for the first queuing device.

10. The system of claim 8, the operations further comprising:
determining that a time window during which an exchange between a current position of a second queuing device and the respective position of a queuing device of the plurality of queuing devices occurs after the exchange between the current position of the first queuing device and the respective position of the queuing device occurs is less than a queuing device exchange time threshold; and
transferring, based on the determining that the time window is less than the queuing device exchange time threshold, a value token to the respective account for the queuing device.

11. The system of claim 10, the operations further comprising:
removing a value token to be removed from an account for the second queuing device when the second queuing device registers with a queuing system based on the determining that the time window is less than the queuing device exchange time threshold.

12. The system of claim 8, the operations further comprising:
identifying another plurality of queuing devices that are each at a respective position of a plurality of positions between a third position and a fourth position based on:
a received identifier that indicates at least of a device type of a second queuing device or an entity associated with the second device, and
an indication that the second queuing device is moving from the third position to the fourth position; and
transferring, for each queuing device of the another plurality of queuing devices, a value token to a respective account for the queuing device when an exchange between a current position of the second queuing device and the respective position of the queuing device occurs.

13. The system of claim 12, wherein, for each queuing device of the another plurality of queuing devices, the transferring the value token to the respective account further comprises sending an instruction to the queuing device that causes the queuing device to move from the respective position when the current position of the second queuing device is in proximity to the queuing device.

14. The system of claim 8, wherein at least one of the first queuing device or the plurality of queuing devices comprises at least one of a includes a vehicle onboard computing device or a mobile device.

15. A non-transitory computer-readable medium having instructions stored thereon that, when executed by at least one computing device, causes the at least one computing device to perform operations for negotiating collective positional exchanges for participants of a queuing system, the operations comprising:
identifying, based on an indication that a first queuing device will move from a first position to a second position, a plurality of queuing devices that are each at a respective position of a plurality of positions between the first position and the second position,
wherein each queuing device of the plurality of queuing devices is associated with a respective positional exchange amount,
wherein, for each queuing device of the plurality of queuing devices, the respective positional exchange amount is based on an exchange between a current position of the first queuing device and the respective position of the queuing device;
sending to the first queuing device, based on a collective positional exchange amount satisfying a positional exchange amount threshold for the first queuing device, an indication of the collective positional exchange amount,
wherein the collective positional exchange amount comprises the respective positional exchange amount for each queuing device of the plurality of queuing devices; and
transferring, based on confirmation of the collective positional exchange amount received from the first queuing device, a value of the respective positional exchange amount for each queuing device of the plurality of queuing devices from an account associated with the first queuing device to a respective account for the queuing device when the exchange between the current position of the first queuing device and the respective position of the queuing device occurs.

16. The non-transitory computer-readable medium of claim 15, the operations further comprising:
determining a service time for the move from the first position to the second position based on at least one of: map information that indicates a distance or a travel rate between the first position and the second position, an indication of a velocity of the first queuing device, a previous service time for the move from the first position to the second position, or third-party information that indicates the service time; and
determining, based on the respective position of each queuing device of the plurality of queuing devices input to a predictive model trained to forecast changes in service times based on positions and attributes of devices, a change in the service time,
wherein the sending to the first queuing device the indication of the collective positional exchange amount is further based on an amount of time associated with the change in the service time satisfying a changed time threshold for the first queuing device.

17. The non-transitory computer-readable medium of claim 15, the operations further comprising:
determining that a time window during which an exchange between a current position of a second queuing device and the respective position of a queuing device of the plurality of queuing devices occurs after the exchange between the current position of the first queuing device and the respective position of the queuing device occurs is less than a queuing device exchange time threshold; and
transferring, based on the determining that the time window is less than the queuing device exchange time threshold, a value token to the respective account for the queuing device.

18. The non-transitory computer-readable medium of claim 17, the operations further comprising:
removing a value token to be removed from an account for the second queuing device when the second queuing device registers with a queuing system based on the determining that the time window is less than the queuing device exchange time threshold.

19. The non-transitory computer-readable medium of claim 15, the operations further comprising:
identifying another plurality of queuing devices that are each at a respective position of a plurality of positions between a third position and a fourth position based on:
a received identifier that indicates at least of a device type of a second queuing device or an entity associated with the second device, and
an indication that the second queuing device is moving from the third position to the fourth position; and
transferring, for each queuing device of the another plurality of queuing devices, a value token to a respective account for the queuing device when an exchange between a current position of the second queuing device and the respective position of the queuing device occurs.

20. The non-transitory computer-readable medium of claim 19, wherein, for each queuing device of the another plurality of queuing devices, the transferring the value token to be transferred to the respective account further comprises sending an instruction to the queuing device that causes the queuing device to move from the respective position when the current position of the second queuing device is in proximity to the queuing device.
